(19) United States
(12) Patent Application Publication
(10) Pub. No.: US 2007/0004459 A1
(43) Pub. Date: Jan. 4, 2007

(54) Method for single key selection of music pieces

(75) Inventor: Ari Aarnio, Espoo (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/173,717

(22) Filed: Jun. 30, 2005

(51) Int. Cl. H04M 1/00

(52) U.S. Cl. 455/564

(57) ABSTRACT

A method comprises storing a speed dial sequence associated with a media file in a memory coupled to a mobile platform, and entering the unique speed dial sequence into the mobile platform to execute the media file.

### TECHNICAL FIELD

This invention relates generally to a method for a user to invoke the execution of a media file. More particularly, the invention relates to the use of user input sequences on mobile platforms, such as mobile phones, for efficiently invoking the execution of media files.

### BACKGROUND

It is well known in the art of engaging in communication via a telephone to designate an abbreviated key sequence to be associated with a phone number. Such key sequences may be as short as a single number, typically ranging from “1” to “9”. Alternatively, such key sequences may be formed of a sequence of numbers, such as “2,3,3”. Once defined, the key sequences may be utilized as short cuts for accessing the phone numbers with which they are associated.

Use of these short cuts when dialing a phone number is commonly referred to as “speed dialing” and the key sequence utilized to perform the speed dialing is referred to as the “speed dial code”. When speed dialing, a user of a phone device need only enter the speed dial code to affect the operation of dialing a desired number. When operated in a stand-by mode, a predetermined entry value, such as “#”, is typically designated to mark the termination of the entry of the speed dial code. For example, if the speed dial code “2,3,3” is associated with the phone number “(212)123-4567”, a phone operator need only dial “2,3,3,#” in order to instruct the telephone to proceed to establish a connection with the associated phone number.

As noted, for maximal speed and efficiency, a speed dial code formed of a single number may be associated with a phone number. For example, the number “2” can be associated with the phone number “(212)123-4567”. In such an instance, depressing the “2” key on the phone keypad will result in dialing the associated phone number. With particular reference to mobile telephones, speed dialing provides an easy method for placing phone calls in situations where the user is otherwise occupied or is prevented from using two hands to operate the phone such as when driving.

As mobile telephone usage continues to increase, mobile phones are increasingly functioning as mobile media platforms. In addition to providing mobile telephone communication, it is not uncommon to utilize mobile telephones to store, access, and transmit multimedia data. As the number of different types of media files, such as MP3 audio files, MPEG video files, or image files, such as JPEG, TIFF, and GIF images, supported by mobile telephone platforms increases, there likewise increases the need for an efficient method for retrieving and playing such files.

### SUMMARY OF THE PREFERRED EMBODIMENTS

In accordance with the invention, a method comprises storing a speed dial sequence associated with a media file in a memory coupled to a mobile platform, and entering the unique speed dial sequence into the mobile platform to execute the media file.

In accordance with an exemplary alternative embodiment, a method comprises storing a speed dial sequence associated with a media file construct in a memory coupled to a mobile platform, and entering the speed dial sequence into the mobile platform to execute the media file construct.

In accordance with an exemplary alternative embodiment, a program of machine-readable instructions, tangibly embodied on an information bearing medium and executable by a digital data processor, to perform actions directed toward executing a media file stored on a mobile platform, the actions comprising receiving as input a speed dial sequence associating a media file with the speed dial sequence, and invoking the execution of the media file.

In accordance with an exemplary alternative embodiment, an apparatus comprises a storage means for associating a speed dial sequence associated with a media file in a memory coupled to a mobile platform, and a means for executing the media file in response to an input of the speed dial sequence at the mobile platform.

### BRIEF DESCRIPTION OF THE DRAWINGS

The foregoing and other aspects of these teachings are made more evident in the following Detailed Description, when read in conjunction with the attached Drawing Figures, wherein:

FIG. 1 is an illustration of an exemplary embodiment of the manipulation of an input sequence.

FIG. 2 is an illustration of an exemplary embodiment of a playlist.

FIG. 3 is an illustration of an exemplary configuration of a mobile platform coupled to a computing device.

FIG. 4 is a flow chart of an exemplary embodiment of the method of the invention.

### DETAILED DESCRIPTION

In an exemplary embodiment of the present invention, there is provided a method for accessing multimedia files on a mobile platform, such as a mobile telephone, through the use of a speed dial sequence. As used herein, “speed dial sequence” relates to a single number or sequence of numbers capable of entry into a mobile device via a keypad or other user interface device. As described more fully below, each unique speed dial sequence is associated with a single media file or media file construct, such as a playlist. Entry of the speed dial sequence into the mobile platform results in the invocation of the media file by an application capable of playing or otherwise executing the media file. While largely described with reference to the entry of speed dial sequences into a mobile telephone or other portable device capable of providing wireless telephony, application of the present invention is not so limited. Rather, the methodology of the present invention is drawn broadly to encompass any and all operating system platforms, in an exemplary embodiment, mobile platforms, capable of storing and retrieving, or otherwise receiving digital media files and presenting such files including, but not limited to, personal digital assistants (PDAs), mobile telephones, Blackberry-type devices, or remote controllers, which can instruct players, e.g. stereos, dvd/music players, tv, set-top-boxes, video recorders, and the like.

In one exemplary embodiment a user can have a collection of different devices which can be controlled by “speed dial sequence” through one or more mobile platforms as above. In yet another exemplary embodiment, a “speed dial sequence” can be installed on a work station or a PC so that a user can utilize a speed dial sequence in instances which would otherwise require use of a full keyboard. In yet one further exemplary embodiment, a user can install a “speed dial sequence” program between devices which have either wired, e.g. USB, or wireless connectivity means, e.g. IR, Bluetooth, UWB, or the like. In a further exemplary embodiment, the “speed dial sequence” can be installed to be part of an electronic service guide in a mobile TV or part of the Electronic Program Guide. In such instances, the sequence of selectable items, services, programs, or files can be shown according to the defined speed dial sequence and the user can use this displayed information in listing programs, services, and files and even use this speed dial sequence when the program, service, file, or media is recorded. The term mobile station refers to any such portable device which has a keypad or the like. In one exemplary embodiment, a mobile station has two-way communication capability with a cellular-based network of relay or base stations, and/or in a further exemplary embodiment, at least a receiver to receive broadcast transmission including FM radio, digital audio broadcasting, digital video broadcasting, digital multimedia broadcasting.

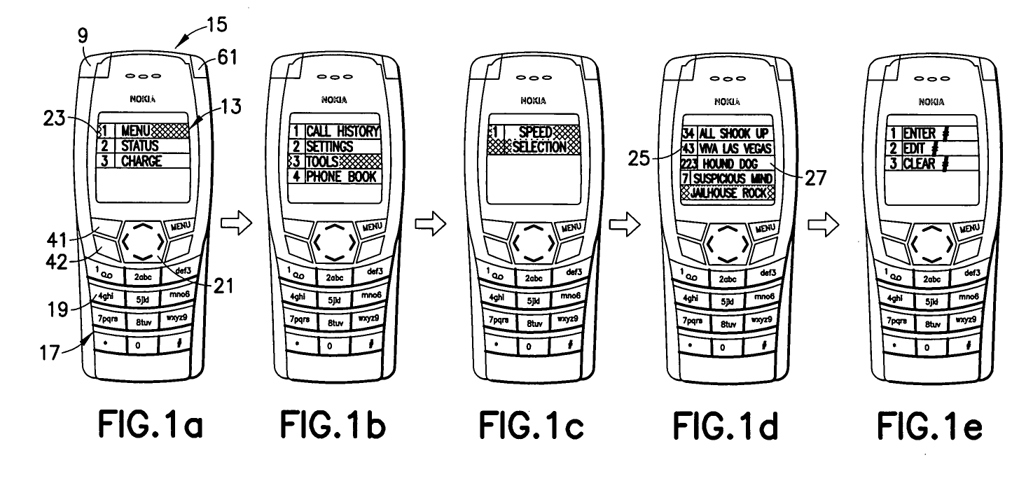

With reference to FIG. 1, there is illustrated an exemplary embodiment of a method by which speed dial sequences may be accessed and assigned to media files, particularly music files, such as MP3 format music files. FIG. 1a shows a mobile station 15 formed of a graphical display 13 and user interface 17. User interface 17 is formed, generally, of input keys 19. User interface 17 may additionally make use of specialized input devices such as a selector 21. Several user options 23 are presented on graphical display 13. For example, “menu”, “status”. and “charge” are displayed. “Menu” is darkened to indicate that it is a highlighted user option 23. The user may scroll up or down the displayed list of user options 23, such as by using selector 21, to highlight the desired user option 23. Once highlighted, the user option 23, in this case “menu”, may be selected, such as by depressing a center portion of selector 21.

In a similar manner, there is illustrated selecting user options 23 corresponding to “tools” and “speed selections” in FIGS. 1b and 1c so as to arrive at FIG. 1d whereat there is illustrated a graphical display 13 showing song titles 27 and associated speed dial sequences 25. For example, the song titled “Viva Las Vegas” is associated with speed dial sequence 25 number “43”. Likewise, the song titled “Suspicious Minds” is associated with speed dial sequence 25 number “7”. While there is illustrated in FIGS. 1a-1d specific graphical displays 13 showing specific user options 23 though which a user can interface with mobile station 15 via a user interface 17 to display and manipulate data related to media files and their corresponding speed dial sequences 25, the invention is not so limited.

It is understood that many methods for displaying user options 23 on a graphical display 13 may be constructed to allow a user to utilize a user interface 17 to activate, highlight, or otherwise select hierarchical or relational data and to act upon such data to add, edit or delete such data. The present invention is drawn broadly to encompass any and all such methods whereby a unique speed dial sequence may be associated with a media file stored upon or retrievable by a mobile phone or other mobile platform.

For example, in an exemplary embodiment of the invention, when a user downloads or otherwise invokes the execution of a media file with which there is not associated a speed dial sequence 25, the graphical display 13 may prompt the user with a message such as, for example, “Do you wish to set a speed dial key?”. In addition, logic can be applied such that a speed dial sequence is suggested to the user which is related in some manner to other speed dial sequences associated with similar media files.

In addition to the pictorial illustration of the selection of user options 23 displayed on a graphical display 13, there is herein employed logical notation for describing such selections. For example, with reference to the selections described in FIGS. 1a-1d, there is illustrated the following selection sequence: Menu→Tools→Speed Selections→Jailhouse Rock.

With continued reference to FIG. 1d, one will note that song title 27 “Jailhouse Rock” does not display an associated speed dial sequence 25. Selecting Menu→Tools→Speed Selections→Jailhouse Rock brings one to the display illustrated in FIG. 1e. As is evident the user is prompted to select “Enter #” to enter an associated speed dial sequence 25, “Edit #” to edit an already existing speed dial sequence 25, or “Clear #” to delete an already existing speed dial sequence 25. It is readily appreciated that subsequent displays and user options 23 can be employed to achieve a desired configuration of media files, such as song titles 27, and associated speed dial sequences 25.

The data formed of the media files and speed dial sequences 25 are preferably saved in non-volatile memory 9 residing in or coupled to mobile station 15.

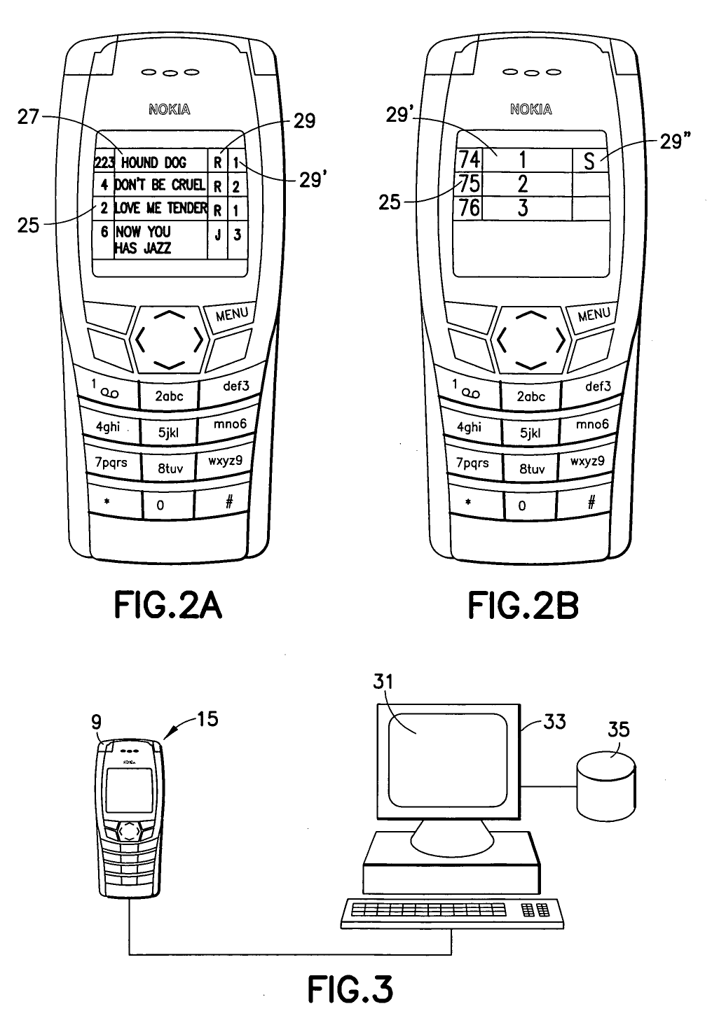

With reference to FIG. 2a, there is illustrated an alternative exemplary embodiment of the invention. Note that, in addition to each speed dial sequence 25 having an associated song title 27, there are also displayed one or more attributes 29, 29′. In the example shown, attribute 29 represents a genre of the speed dial sequence 25 selection. For example, “R” designates a rock song, while “J” designates a jazz selection.

Furthermore, attribute 29′ indicates a playlist to which the selection belongs. For example, “Hound Dog” and “Love Me Tender” have been designated as belonging to playlist “1”. With reference to FIG. 2b, it is evident that playlists 29′ can likewise have associated speed dial sequences 25. For example, playlist 29′ “1” is associated with speed dial sequence 25 number “74”. As will be discussed more fully below, invoking speed dial sequence 25 number “74” will cause playlist number “1” to execute. Note further that playlist 29′ number “1” has an associated attribute 29″ describing the manner in which playlist number “1” is to be executed. In the example shown, playlist “1” has an associated attribute 25 “S” indicating that playlist number “1” is to be executed in a shuffle mode. For example, “Hound Dog” and “Love Me Tender” will be played in a random or shuffle mode.

While illustrated thus far with reference to speed dial sequences 25 associated with song titles 27, corresponding to audio files stored upon the mobile station 15, playlists 29′, and additional desired attributes 29,29″, it is understood that additional configurations may be implemented. It is required only that, at a minimum, a unique speed dial sequence 25 is associated with only one media file or grouping of media files, such as a playlist, which can in turn be resolved to specify a defined set or subset of media files which may be invoked in a predefined manner.

With reference to FIG. 3, there is illustrated an exemplary embodiment of the invention. Mobile station 15 is coupled to remote interface 31. Remote interface 31 is typically a user interface running on a computing device 33 such as a personal computer that makes use of a graphical user interface (GUI) for viewing, entering, and editing data. Such a coupling may be affected via the utilization of wireless communication connection or a physical connection such as that provided by a USB, serial, or other hardwire connection. Once coupled so that data may be communicated between mobile station 15 and remote interface 31, speed dial sequence data may be accessed by computing device 33. A remote interface 31 running on a computing device 33 is typically more robust and easier to utilize for manipulating the speed dial sequence data than is the user interface 17 and attendant graphical display 13 of a mobile station 15. As a result, speed dial sequence data can be manipulated on computing device 33 and synchronized with the data stored in memory 9 of the mobile station 15. Archived copies of speed dial sequence data may be stored upon a memory 35 coupled to computing device 33.

In addition, computing device 33 may be utilized to receive media file data, reformat such data as necessary, and transmit such data to the mobile station 15. For example, a song contained upon an audio CD may be inputted to computing device 33 whereupon it is converted to an MP3 audio file, and transmitted for storage upon mobile station 15. Likewise, a video file may be converted to an MPEG file, and transmitted for storage upon mobile station 15. Further, the playlists' attributes may be created, edited, and modified on the computing device and updated or otherwise imported to the mobile station 15. In this manner, speed dial sequence data can be manipulated and transmitted along with media files to mobile station 15.

Once the speed dial sequence data, including speed dial sequences and associated media files, playlists, and other attributes, is resident upon mobile station 15 along with the media files referenced in the data, a user of the mobile station 15 can readily invoke media files by entering the desired associated speed dial sequence 25.

In an exemplary embodiment, media files are associated with speed dial sequences 25 formed of a single digit, typically from “1” to “9”. When the mobile station 15 is in a standby mode, depressing any of numbers “1” to “9” on user interface 17 followed by pressing, or otherwise activating, a speed dialing key 41, a soft key 42, or other key such as “#” or “*”, results in the invocation of the media file associated with the speed dial sequence 25 corresponding to the entered digit. In another exemplary embodiment, the single digits capable of being used as speed dial sequences 25 range from “2” through “9” with “1” being reserved to access phone mail. Alternatively, if the mobile station 15 has been placed in a speed dial mode, pressing the key corresponding to the desired digit and holding it for a predefined period of time will result in invocation of the associated media file.

It should be noted that the speed dial sequence data may additionally include traditional speed dial key sequences associated with numbers to be dialed. Such traditional speed dial key sequences may be the same as an individual one of he speed dial sequences described herein associated with media files or a media file construct. In such instances, separate keys can be designated to designate, upon entry of a sequence, whether the sequence is a speed dial sequence associated with a media file or a phone number. For example, entering “7,#” may result in the execution of a media file associated with “7”, while entering “7,*” may result in dialing a predefined phone number. In this example, the termination characters, “#” or “*”, determine the action resulting from the keyed entry.

The form of invocation depends upon the format of the associated media file. For example, invocation of an audio file will result in the outputting of sound from mobile station 15. Similarly, invocation of a video file will result in the outputting of sound and video from mobile station 15. In the instance that mobile station 15 is able to output only a portion of the data contained within a media file, it will output that which it can output. For example, a mobile station 15 lacking a graphical display 13 for outputting the video portion of a video file may still output the audio portion.

In an alternative exemplary embodiment wherein speed dial sequences 25 are formed of multiple digits, there are various methods by which a user may enter the speed dial sequences.

It must be stated that, in addition to the definition for speed dialing sequence provided above, as used herein “speed dialing sequence” refers to a sequence of digits for invoking a media file which is different than or unrelated to any key sequence for invoking a media file derived from the navigation of menu options. For example, in addition to displaying user options 23 in a text format, user options 23 are often times displayed as corresponding to single digit key entries. In this way, a user can, for example, perform the navigated steps of Menu→Tools→Speed Selections→Suspicious Minds by pressing the following sequence 1,3,1,4 as illustrated in FIGS. 1a-1d. Note, however, that the speed dial sequence 25 for this selection is “7”. As defined herein, the speed dial sequence “7” is, of necessity, different than “1,3,1,4”.

In standby mode, invocation of a media file may be realized by entering a speed dial sequence 25, for example 2,2,3 and holding the last entry down for an extended period of time sufficient to indicate the end of the sequence and the beginning of the invocation of the associated media file. As with a single digit speed dial sequence 25, a speed dialing key 41 or a soft key may be depressed to signal the end of the sequence and the invocation of the media file.

Typically, the media file or files to be invoked through entering a speed dial sequence 25 will reside in memory 9 coupled to the mobile station 15. In an exemplary alternative embodiment, invocation of a media file or media file construct, such as a playlist, may require receiving the media file or files from a remote host, such as computing device 33, via a connection, preferably as wireless connection.

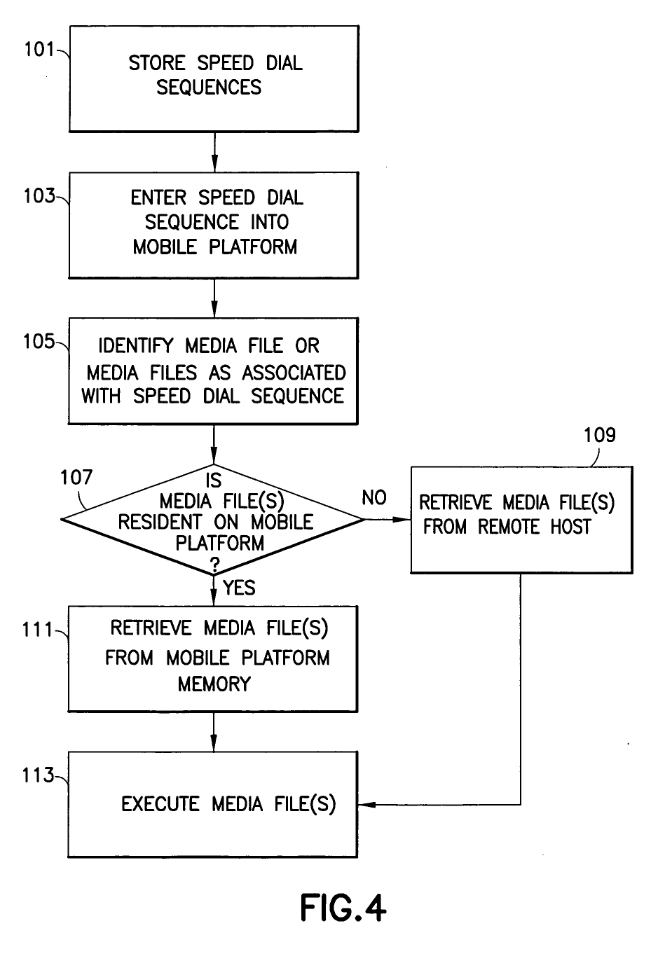

With reference to FIG. 4, there is illustrated the methodology by which a speed dial sequence or sequences is entered and a corresponding media file or files is executed. At block 101 a speed dial sequence 25 or sequences is stored in a memory 9 coupled to mobile station 15. At block 103, a speed dial sequence 25 is entered into mobile station 15. At block 105, the media file or files associated with the entered speed dial sequence 25 are identified and, at block 107, a check is performed to ascertain if the media file to be executed is resident in memory 9 coupled to the mobile station 15. If the media file is resident in the memory 9, the media file to be executed is retrieved from memory 9 at block 111 and executed at block 113. If the requested media file is not resident in memory 9, the media file is retrieved from a remote host at block 109. The accessing and execution of media files is performed by utilizing a digital data processor 61 resident within or coupled to the mobile station 15.

While described with reference to a speed dial sequence 25 associated to a single media file or media file construct, it is not necessary that the media file or media file construct associated with a speed dial sequence be static or unchanging. With particular reference to the retrieval of media files from a remote host, the associated media file may change in content. For example, a speed dial sequence 25 may be associated with a media file corresponding to the most recent broadcast of a radio program. Entering such a speed dial sequence 25 will result in the remote retrieval and execution of an audio file comprising content which may change over time.

In another exemplary embodiment, the user interface can be used to link a speed dial sequence 25 to a media file which may change over time in dynamic fashion. For example, with reference to an electronic service guide, a user, having scrolled to an available service and selected it, can select a speed dial sequence 25to be associated to that selected service, program, or file. The selected program, service, or file can be stored to the memory of the mobile device, for example a mobile TV, and when the mobile device receives the next service guide update, the speed dial sequence 25 can be linked to the earlier specified program, service or file. In this manner, recording a program, service or file results in the automatic storage of the program as well as automatic linking to the appropriate speed dial sequence 25.

In an alternative exemplary embodiment, a user is provided with a separate “normal” remote controller which can have the “speed dial sequence” program embedded in the remote controller so that user can use keys in in the remote controller in a similar manner as the keys used in the mobile phone for selecting music and/or video. In such an instance, stereos, television and/or set top boxes and the like would need to have a controller to get commands in order to interpret the commands of a speed dial sequence in a proper way. Speed dial sequences 25 can be transmitted from a phone to a user's consumer electronics device and to the remote controller through various number of interfaces and/or carriers. The remote controller speed dial sequences 25 may be programmed by a user using selections from a remote controller and using as display the respective consumer electronics device screen such as a tv screen so that user can see which sequence reflects which numbers and/or keys. In one further exemplary embodiment, one screen can be connected to different consumer electronics devices (e.g. all home network devices are connected) so that user can compute and control from that one screen which devices can be programmed or which ones are programmed by which keys and functions.

In an alternative exemplary embodiment, the speed dial sequence 25 may be a key for the user to access broadcast programs or even podcasting so that user can always get the most relevant content in which there has been expressed an interest. The speed dial sequence 25 program can be embedded in the device so that it can guide a user to select the right channel.

In one yet another exemplary embodiment, the speed dial sequence 25 can be the same as a user's home phone number. As a result, the user's home phone number, depending on the application, can have different actions in a mobile station, i.e. in a phone application the number will lead to a call home, but in connection with media file it will be linked with a speed dial sequence 25. Also, when entering a home phone number requiring a lengthy inputting of data, predictive number feeding may be employed so that one or more first digits will reveal an entire speed dial sequence.

1. A method comprising:
storing a speed dial sequence associated with a media file in a memory coupled to a mobile platform; and
entering said speed dial sequence into said mobile platform to execute said media file.

2. The method of claim 1 comprising associating at least one attribute with said speed dial sequence.

3. The method of claim 2 wherein said at least one attribute comprises a genre

4. The method of claim 2 wherein said at least one attribute comprises a playlist.

5. The method of claim 1 wherein said entering said speed dial sequence comprises:
inputting said speed dial sequence; and
activating a speed dial key.

6. The method of claim 1 wherein said entering said speed dial sequence comprises:
inputting said speed dial sequence; and
activating a soft key.

7. The method of claim 1 wherein said entering said speed dial sequence comprises:
inputting said speed dial sequence; and
activating a key selected from the group consisting of“*” and “#”.

8. The method of claim 1 wherein the mobile platform comprises a mobile phone.

9. The method of claim 1 wherein the mobile platform comprises a personal digital assistant (PDA).

10. The method of claim 1 wherein said media file is selected from the group consisting of an audio file, an MP3 file, a video file, an image file, and an MPEG file.

11. The method of claim 1 comprising:
entering speed dial sequence data comprising said speed dial sequence into a computing device; and
communicating said speed dial sequence data to said mobile platform.

12. The method of claim 11 wherein said communicating is performed via a physical connection.

13. The method of claim 11 wherein said communicating is performed via a wireless connection.

14. The method of claim 1 wherein said media file is stored in said memory.

15. A method comprising:
storing a speed dial sequence associated with a media file construct in a memory coupled to a mobile platform; and
entering said speed dial sequence into said mobile platform to execute said media file construct.

16. The method of claim 15 wherein said media file construct is a playlist.

17. The method of claim 16 wherein at least one attribute is associated with said playlist.

18. The method of claim 17 wherein said attribute indicates a shuffle mode.

19. A program of machine-readable instructions, tangibly embodied on an information bearing medium and executable by a digital data processor, to perform actions directed toward executing a media file stored on a platform, the actions comprising:
receiving as input a speed dial sequence; and
associating a media file with said speed dial sequence.

20. The program of claim 19 further comprising invoking the execution of said media file associated with the received speed dial sequence.

21. The program of claim 19 wherein said speed dial sequence comprises at least one digit.

22. The program of claim 19 wherein said associating comprises accessing speed dial sequence data from a memory coupled to said platform.

23. The program of claim 22 wherein said media file is stored in said memory.

24. The program of claim 19 wherein said media file is stored on a remote host.

25. The program of claim 19 wherein said platform is a mobile phone.

26. The program of claim 19 wherein said platform is a personal digital assistant (PDA).

27. An apparatus comprising:
storage means for storing a speed dial sequence associated with a media file in a memory coupled to a mobile platform; and
means for executing said media file in response to an input of the speed dial sequence at said mobile platform.

28. The apparatus of claim 27 comprising means for associating at least one attribute with said speed dial sequence.
